(19) United States
(12) Patent Application Publication
(10) Pub. No.: US 2012/0121921 A1
(43) Pub. Date: May 17, 2012

(54) AQUEOUS POLYMER DISPERSION AS A BINDING AGENT FOR PLASTERS AND COATING MATERIALS HAVING IMPROVED FIRE BEHAVIOR

(75) Inventors: Audrey Cosyns, Mannheim (DE); Sebastian Roller, Mannheim (DE); Alexandre Terrenoire, Sprendlingen (DE); Roland Baumstark, Neustadt (DE); Ekkehard Jahns, Weinheim (DE); Robert Rupaner, Ellerstadt (DE)

(73) Assignee: BASF SE, Ludwigshafen (DE)

(21) Appl. No.: 13/384,605

(22) PCT Filed: Jul. 21, 2010
(86) PCT No.: PCT/EP2010/060511

§ 371 Date: Jan. 18, 2012

(30) Foreign Application Priority Data
Jul. 22, 2009 (EP) 09166111.6

(51) Int. Cl. B32B 27/36; E04B 1/78; C09J 133/12; C08L 33/10; C09D 133/12

(52) U.S. Cl. 428/522; 524/560; 524/561; 252/62

(57) ABSTRACT

Use of an aqueous polymer dispersion comprising at least one polymer (P), obtainable by free radical emulsion polymerization of at least one ethylenically unsaturated monomer (M1) and from 20 to 75% by weight of tert-butyl (meth)acrylate, as a binder in construction chemistry products.

In practice, aqueous polymer dispersions are used in large quantities for construction adhesives, filling compounds, renders and paints. Such construction adhesives, filling compounds and renders, which are used in association with the heat insulation of buildings, in particular for complete heat insulation measures, have to meet particular requirements. Heat insulation boards, for example rigid polystyrene foam boards or mineral fiberboards, are, for example, adhesively bonded on façade surfaces and then leveled with a filling compound or reinforcing fabric and surface-coated with dispersion-bound renders. An important property of the composite heat insulation systems (CHIS) is the flame retardance of the total system. It is necessary to take into account that, in addition to the fire properties of the insulation board, the organic constituents in adhesive, reinforcement and finish coat also play a role in determining the fire behavior. Also important is which polymer classes are used for the production of these components.

It is known that complete heat insulation systems are among construction materials for which a test mark is mandatory. The polymer dispersions preferably used for the outer coating, i.e. for renders and paints, owing to their good light fastness and weathering resistance and based on (meth)acrylates or copolymers thereof with styrene must therefore be processed with addition of fireproofing agents. The polyvinyl ester dispersions or terpolymer dispersions which are composed of vinyl chloride, ethylene and vinyl acetate are suitable, owing to the advantageous fire behavior of their films, for the production of renders and paints even without or with a small addition of usually hydrophilizing inorganic fireproofing agents, but this advantage must be obtained at the expense of increased yellowing, faster soiling and weathering. In addition, such binders often absorb increased amounts of water, which may lead to growth of algae or fungal attack on the surfaces.

Finally, during fires, the vinyl chloride-containing polymers eliminate hydrochloric acid, which may lead to secondary fire damage. Furthermore, there is the risk of formation of toxic secondary products (for example dioxins) in the event of fire. In practice, to achieve a compromise between fine protection and use properties, dispersion mixtures consisting of styrene-acrylate copolymers and vinyl chloride-ethylene-vinyl acetate copolymers are therefore frequently used for outer coatings.

In practice, inter alia for reasons relating to simpler stocking, polymer dispersions are therefore desired which are suitable both for the production of construction adhesives and filling compounds and for the production of renders and paints and which, in case of fire, eliminate no hydrochloric acid and form no toxins which can endanger the firefighting team and moreover can give rise to secondary damage to the structure. EP 0 103 253 discloses binders for construction adhesives, filling compounds and renders (in particular for complete heat insulation systems) which are composed of from 55 to 72% by weight of vinyl propionate, from 27.5 to 44.9% by weight of tert-butyl acrylate, from 0.1 to 0.5% by weight of (meth)acrylic acid and optionally further comonomers. However, these binders are still unsatisfactory with regard to the fire behavior and the stability to hydrolysis, and require the use of the vinyl propionate monomer which is nowadays obtainable only with difficulty on the market.

EP 0 334 214 discloses binders for variegated stone renders based on synthetic resin. These binders are composed of from 60 to 100% by weight of tert-butyl esters of acrylic and methacrylic acid, from 0 to 40% by weight of an acrylate or methacrylate of a non-tertiary C₁-C₂₀-alkanol, from 0 to 20% by weight of vinyl chloride, vinyl acetate and/or vinyl propionate, from 0 to 10% by weight of (meth)acrylic acid and/or (meth)acrylamide and from 0 to 5% by weight of other copolymerizable monomers. However, these binders do not drip flaming particles in the event of a fire, and lead to significant evolution of heat at the start of the burning process due to escape of combustible isobutene.

It was accordingly an object of the present invention to provide polymer dispersions which give transparent, lightfast, hydrolysis- and weathering-resistant films and which are suitable for the production of water-resistant, hydrolysis-resistant, weathering- and yellowing-stable, flame-retardant renders and paints. In particular, they should be capable of being used for complete heat insulation systems comprising little or no cement, i.e. for fixing and coating heat insulation boards in the insulation of buildings, should not eliminate hydrogen chloride in the event of a fire and should have good fire properties (no dripping of flaming particles, prevention of flame spread, compliance with specific tests, e.g. SBI, Brandschacht tests, etc.).

It has now been found that this object is achieved by the use of an aqueous polymer dispersion comprising at least one polymer (P), obtainable by free radical emulsion polymerization of at least one ethylenically unsaturated monomer (M1) and from 20 to 75% by weight of tert-butyl (meth)acrylate, as a binder for construction adhesives, filling compounds, paints and renders, in particular for complete heat insulation systems.

Construction adhesives, filling compounds, paints, renders and composite heat insulation systems are also summarized below under the term construction chemistry products.

The aqueous polymer dispersions according to the invention are particularly advantageously suitable for adhesive bonding of heat insulation boards, for example based on styrene polymers, and of glass foam sheets and cork boards, foamed silicate insulation boards, rigid polyurethane foam boards and mineral fiber insulation materials, such as rockwool. They can also be used as binders for paints.

The invention firstly relates to the use of an aqueous polymer dispersion comprising from 20 to 75% by weight of tert-butyl (meth)acrylate, preferably from 25 to 60%, particularly preferably from 30 to 45%, and at least one ethylenically unsaturated monomer differing therefrom and obtainable by free radical emulsion polymerization, as a binder in construction chemistry products, in particular for improving the fire behavior.

The invention furthermore relates to construction chemistry products, such as paints, renders, construction adhesives, filling compounds and composite heat insulation systems comprising the aqueous polymer dispersions according to the invention, having improved fire behavior.

The invention furthermore relates to the preferably used polymer dispersions described below, and renders, construction adhesives, filling compounds and paints in the form of an aqueous composition, comprising at least one polymer dispersion used according to the invention.

In the context of the present invention, the expression “alkyl” comprises straight-chain and branched alkyl groups, especially having 1 to 8 carbon atoms, i.e. “C₁-C₈-alkyl”.

Suitable short-chain alkyl groups are, for example, straight-chain or branched C₁-C₇-alkyl, preferably C₁-C₆-alkyl and particularly preferably C₁-C₄-alkyl groups. These include in particular methyl, ethyl, propyl, isopropyl, n-butyl, 2-butyl, sec-butyl, tert-butyl, n-pentyl, 2-pentyl, 2-methylbutyl, 3-methylbutyl, 1,2-dimethylpropyl, 1,1-dimethylpropyl, 2,2-dimethylpropyl, 1-ethylpropyl, n-hexyl, 2-hexyl, 2-methylpentyl, 3-methylpentyl, 4-methylpentyl, 1,2-dimethylbutyl, 1,3-dimethylbutyl, 2,3-dimethylbutyl, 1,1-dimethylbutyl, 2,2-dimethylbutyl, 3,3-dimethylbutyl, 1,1,2-trimethylpropyl, 1,2,2-trimethylpropyl, 1-ethylbutyl, 2-ethylbutyl, 1-ethyl-2-methylpropyl, n-heptyl, 2-heptyl, 3-heptyl, 2-ethylpentyl, 1-propylbutyl etc.

The above statements regarding alkyl also apply in context to the alkyl groups in alkanol, alkanediol and aminoalkanol.

The expression “alkylene” as used in alkyleneoxy represents straight-chain or branched alkanediyl groups, preferably having 1 to 7 carbon atoms, such as, for example, methylene, 1,2-ethylene, 1,2-propylene, 1,3-propylene, 1,2-butylene, 1,3-butylene, 1,4-butylene, 2-methyl-1,2-propylene, etc.

In the context of this application, the expression tert-butyl (meth)acrylate means tert-butyl acrylate and/or tert-butyl methacrylate.

The polymer dispersion used according to the invention comprises at least one polymer (P) obtainable by free radical emulsion polymerization of at least one ethylenically unsaturated monomer (M1) and tert-butyl (meth)acrylate.

For the preparation of the polymer dispersion used according to the invention, preferably at least one α,β-ethylenically unsaturated monomer (M1) is used, which is preferably selected from esters of α,β-ethylenically unsaturated mono- and dicarboxylic acids with C₁-C₈-alkanols, esters of vinyl or allyl alcohol with C₁-C₈-monocarboxylic acids, monoethylenically unsaturated carboxylic and sulfonic acids, primary amides of α,β-ethylenically unsaturated monocarboxylic acids and the N-alkyl and N,N-dialkyl derivatives thereof, and mixtures thereof.

Further suitable monomers (M1) are, for example, vinylaromatics, ethylenically unsaturated nitriles, esters of α,β-ethylenically unsaturated mono- and dicarboxylic acids with C₂-C₈-alkanediols, amides of α,β-ethylenically unsaturated mono- and dicarboxylic acids with C₂-C₈-amino alcohols, N-vinyllactams, open-chain N-vinylamide compounds, esters of α,β-ethylenically unsaturated mono- and dicarboxylic acids with amino alcohols, amides of α,β-ethylenically unsaturated mono- and dicarboxylic acids with diamines, N,N-diallylamines, N,N-diallyl-N-alkylamines, vinyl- and allyl-substituted nitrogen heterocycles and mixtures thereof.

Suitable esters of α,β-ethylenically unsaturated mono- and dicarboxylic acids with C₁-C₈-alkanols are methyl (meth)acrylate, methyl ethacrylate, ethyl (meth)acrylate, ethyl ethacrylate, n-propyl (meth)acrylate, isopropyl (meth)acrylate, n-butyl (meth)acrylate, sec-butyl (meth)acrylate, n-hexyl (meth)acrylate, n-heptyl (meth)acrylate, n-octyl (meth)acrylate, 1,1,3,3-tetramethylbutyl (meth)acrylate, ethylhexyl (meth)acrylate and mixtures thereof.

Suitable esters of vinyl alcohol with C₁-C₈-monocarboxylic acids are, for example, vinyl formate, vinyl acetate, vinyl butyrate, vinyl laurate, vinyl stearate, vinyl versatate and mixtures thereof.

Suitable ethylenically unsaturated carboxylic acids and sulfonic acids or derivatives thereof are acrylic acid, methacrylic acid, ethacrylic acid, α-chloroacrylic acid, crotonic acid, maleic acid, maleic anhydride, itaconic acid, citraconic acid, mesaconic acid, glutaconic acid, aconitic acid, fumaric acid, the monoesters of monoethylenically unsaturated dicarboxylic acids having 4 to 10, preferably 4 to 6, carbon atoms, e.g. monomethyl maleate, vinylsulfonic acid, allylsulfonic acid, sulfoethyl acrylate, sulfoethyl methacrylate, sulfopropyl acrylate, sulfopropyl methacrylate, 2-hydroxy-3-acryloxypropylsulfonic acid, 2-hydroxy-3-methacryloxypropylsulfonic acid, styrenesulfonic acids and 2-acrylamido-2-methylpropanesulfonic acid. Suitable styrenesulfonic acids and derivatives thereof are styrene-4-sulfonic acid and styrene-3-sulfonic acid and the alkaline earth metal or alkali metal salts thereof, e.g. sodium styrene-3-sulfonate and sodium styrene-4-sulfonate. Acrylic acid, methacrylic acid and mixtures thereof are particularly preferred.

Suitable primary amides of α,β-ethylenically unsaturated monocarboxylic acids and the N-alkyl and N,N-dialkyl derivatives thereof are acrylamide, methacrylamide, N-methyl(meth)acrylamide, N-ethyl(meth)acrylamide, N-propyl(meth)acrylamide, N-(n-butyl)(meth)acrylamide, N-(tert-butyl)(meth)acrylamide, N-(n-octyl)(meth)acrylamide, N-(1,1,3,3-tetramethylbutyl)(meth)acrylamide, N-ethylhexyl(meth)acrylamide, N,N-dimethyl(meth)acrylamide, N,N-diethyl(meth)acrylamide, morpholinyl(meth)acrylamide and mixtures thereof.

Suitable vinylaromatics are styrene, α-methylstyrene, 2-methylstyrene, 4-methylstyrene, 2-(n-butyl)styrene, 4-(n-butyl)styrene, in particular styrene; other hydrocarbons are butadiene, divinylbenzene, ethylene and 2-methylbutadiene.

Suitable ethylenically unsaturated nitriles are acrylonitrile, methacrylonitrile and mixtures thereof.

Suitable esters of α,β-ethylenically unsaturated mono- and dicarboxylic acids with C₂-C₃₀-alkanediols are, for example, 2-hydroxyethyl acrylate, 2-hydroxyethyl methacrylate, 2-hydroxyethyl ethacrylate, 2-hydroxypropyl acrylate, 2-hydroxypropyl methacrylate, 3-hydroxypropyl acrylate, 3-hydroxypropyl methacrylate, 3-hydroxybutyl acrylate, 3-hydroxybutyl methacrylate, 4-hydroxybutyl acrylate, 4-hydroxybutyl methacrylate, 6-hydroxyhexyl acrylate, 6-hydroxyhexyl methacrylate, 3-hydroxy-2-ethylhexyl acrylate, 3-hydroxy-2-ethylhexyl methacrylate and mixtures thereof.

Suitable amides of α,β-ethylenically unsaturated mono- and dicarboxylic acids with C₂-C₈-amino alcohols are, for example, N-(2-hydroxyethyl)acrylamide, N-(2-hydroxyethyl)-methacrylamide, N-(2-hydroxyethyl)ethacrylamide, N-(2-hydroxypropyl)acrylamide, N-(2-hydroxypropyl)methacrylamide, N-(3-hydroxypropyl)acrylamide, N-(3-hydroxy-propyl)methacrylamide, N-(3-hydroxybutyl)acrylamide, N-(3-hydroxybutyl)methacrylamide, N-(4-hydroxybutyl)acrylamide, N-(4-hydroxybutyl)methacrylamide, N-(6-hydroxyhexyl)-acrylamide, N-(6-hydroxyhexyl)methacrylamide, N-(3-hydroxy-2-ethylhexyl)acrylamide, N-(3-hydroxy-2-ethylhexyl)methacrylamide, N-methyl-N-(2-hydroxyethyl)acrylamide, N-methyl-N-(2-hydroxyethyl)methacrylamide, N-methyl-N-(2-hydroxypropyl)acrylamide, N-methyl-N-(2-hydroxypropyl)methacrylamide, N-methyl-N-(3-hydroxypropyl)acrylamide, N-methyl-N-(3-hydroxypropyl)methacrylamide, N-methyl-N-(3-hydroxybutyl)acrylamide, N-methyl-N-(3-hydroxybutyl)methacrylamide, N-methyl-N-(4-hydroxybutyl)acrylamide, N-methyl-N-(4-hydroxybutyl)methacrylamide, N-methyl-N-(6-hydroxyhexyl)acrylamide, N-methyl-N-(6-hydroxyhexyl)methacrylamide, N-methyl-N-(3-hydroxy-2-ethyl-hexyl)acrylamide, N-methyl-N-(3-hydroxy-2-ethylhexyl)methacrylamide and mixtures thereof.

Suitable N-vinyllactams and derivatives thereof are, for example, N-vinylpyrrolidone, N-vinylpiperidone, N-vinylcaprolactam, N-vinyl-5-methyl-2-pyrrolidone, N-vinyl-5-ethyl-2-pyrrolidone, N-vinyl-6-methyl-2-piperidone, N-vinyl-6-ethyl-2-piperidone, N-vinyl-7-methyl-2-caprolactam, N-vinyl-7-ethyl-2-caprolactam and mixtures thereof.

Suitable open-chain N-vinylamide compounds are, for example, N-vinylformamide, N-vinyl-N-methylformamide, N-vinylacetamide, N-vinyl-N-methylacetamide, N-vinyl-N-ethylacetamide, N-vinylpropionamide, N-vinyl-N-methylpropionamide, N-vinylbutyramide and mixtures thereof.

Suitable esters of α,β-ethylenically unsaturated mono- and dicarboxylic acids with amino alcohols are N,N-dimethylaminomethyl (meth)acrylate, N,N-dimethylaminoethyl (meth)acrylate, N,N-diethylaminoethyl acrylate, N,N-dimethylaminopropyl (meth)acrylate, N,N-diethylaminopropyl (meth)acrylate, N,N-dimethylaminocyclohexyl (meth)acrylate and mixtures thereof.

Suitable amides of α,β-ethylenically unsaturated mono- and dicarboxylic acids with diamines which have at least one primary or secondary amino group are N-[2-(dimethyl-amino)ethyl]acrylamide, N-[2-(dimethylamino)ethyl]methacrylamide, N-[3-(dimethylamino)-propyl]acrylamide, N-[3-(dimethylamino)propyl]methacrylamide, N-[4-(dimethylamino)butyl]-acrylamide, N-[4-(dimethylamino)butyl]methacrylamide, N-[2-(diethylamino)ethyl]-acrylamide, N-[4-(dimethylamino)cyclohexyl]acrylamide, N-[4-(dimethylamino)cyclohexyl]-methacrylamide and mixtures thereof.

Suitable monomers (M1) are furthermore N,N-diallylamines and N,N-diallyl-N-alkylamines and acid addition salts and quaternization products thereof. Alkyl is preferably C₁-C₈-alkyl. N,N-diallyl-N-methylamine and N,N-diallyl-N,N-dimethylammonium compounds, such as, for example, the chlorides and bromides, are preferred.

Suitable monomers (M1) are furthermore vinyl- and allyl-substituted nitrogen heterocycles, such as N-vinylimidazole, N-vinyl-2-methylimidazole, vinyl- and allyl-substituted heteroaromatic compounds, such as 2- and 4-vinylpyridine, 2- and 4-allylpyridine and the salts thereof.

The abovementioned monomers (M1) can be used individually, in the form of mixtures within one monomer class or in the form of mixtures of different monomer classes.

Preferred polymers (P) are obtainable by an emulsion polymerization in which the proportion of the monomers (M1) is in the range from 25 to 80% by weight, particularly preferably in the range from 40 to 75% by weight and very particularly preferably in the range from 55 to 70% by weight, based in each case on the total weight of the monomers used for the emulsion polymerization.

Also preferred are polymers (P) which are obtainable by an emulsion polymerization in which the main proportion of the monomers (M1) (referred to below as main monomers (HM)), i.e. at least 50% by weight, preferably at least 60% by weight and particularly preferably at least 80% by weight, based on the total weight of the monomers (M1), is selected from the esters of α,β-ethylenically unsaturated mono- and dicarboxylic acids with C₁-C₈-alkanols, esters of vinyl or allyl alcohol with C₁-C₈-monocarboxylic acids, monoethylenically unsaturated carboxylic and sulfonic acids, primary amides of α,β-ethylenically unsaturated monocarboxylic acids and the N-alkyl and N,N-dialkyl derivatives thereof, vinylaromatics and mixtures thereof, which are mentioned above as being preferred. The main monomers (HM) are particularly preferably selected from esters of α,β-ethylenically unsaturated mono- and dicarboxylic acids with C₁-C₈-alkanols, especially from methyl (meth)acrylate, ethyl (meth)acrylate, n-propyl (meth)acrylate, isopropyl (meth)acrylate, n-butyl (meth)acrylate, sec-butyl (meth)acrylate, n-pentyl (meth)acrylate, n-hexyl (meth)acrylate, n-heptyl (meth)acrylate, n-octyl (meth)acrylate, 2-ethylhexyl (meth)acrylate, styrene and mixtures thereof.

A particularly suitable mixture of tert-butyl (meth)acrylate with main monomers (HM) for the process according to the invention is, for example, tert-butyl (meth)acrylate with methyl methacrylate. Further preferred mixtures of main monomers with tert-butyl (meth)acrylate are n-butyl acrylate/methyl methacrylate, n-butyl acrylate/styrene, n-butyl acrylate/vinyl acetate, n-butyl acrylate/methyl methacrylate/vinyl acetate, n-butyl acrylate/ethyl acrylate/vinyl acetate, n-butyl acrylate/methyl methacrylate/ethyl acrylate.

The secondary proportion of the monomers M1 (referred to below as secondary monomers (NM)), i.e. up to 50% by weight, preferably up to 40% by weight and particularly preferably up to 20% by weight, based on the total weight of the monomers (M1), is preferably selected from ethylenically unsaturated mono- and dicarboxylic acids and the anhydrides and monoesters of ethylenically unsaturated dicarboxylic acids, (meth)acrylamides, C₁-C₈-hydroxyalkyl (meth)acrylates, C₁-C₈-hydroxyalkyl(meth)acrylamides and mixtures thereof. The secondary monomers (NM) are particularly preferably selected from acrylic acid, methacrylic acid, itaconic acid, maleic acid, fumaric acid, maleic anhydride, acrylamide, methacrylamide, hydroxyethyl (meth)acrylate and mixtures thereof.

Usually, the secondary monomers (NM), if present, are used in an amount of at least 0.1% by weight, preferably at least 0.5% by weight and particularly preferably at least 2% by weight, based on the total weight of the monomers (M1), for the emulsion polymerization.

The abovementioned particularly suitable mixture of main monomers (HM) can be combined with secondary monomers (NM), which are selected in particular from acrylic acid, methacrylic acid, itaconic acid, acrylamide, methacrylamide and mixtures thereof.

In a specific embodiment, the monomers (M1) comprise exclusively monomers which are selected from the main monomers (HM) mentioned above as being preferred.

According to the invention, the polymer (P) is obtainable by free radical emulsion polymerization of at least one of the monomers (M1) described above and tert-butyl (meth)acrylate.

In the preparation of the polymers (P) used according to the invention, at least one crosslinking agent may be used in addition to the abovementioned monomers (M1) and tert-butyl (meth)acrylate.

Monomers which have a crosslinking function are compounds having at least two polymerizable, ethylenically unsaturated, nonconjugated double bonds in the molecule.

Crosslinking can also be effected, for example, by photochemical activation. For this purpose, at least one monomer having photoactivatable groups can additionally be used for the preparation of the polymers (P). Photoinitiators can also be added separately.

Crosslinking can also be effected, for example, by functional groups which can undergo a chemical crosslinking reaction with functional groups complementary to them. The complementary groups may both be bonded to the emulsion polymer. A crosslinking agent which is capable of undergoing a chemical crosslinking reaction with functional groups of the emulsion polymer can be used for crosslinking.

Suitable crosslinking agents are, for example, acrylates, methacrylates, allyl ethers or vinyl ethers of at least dihydric alcohols. The OH groups of the parent alcohols can be completely or partially etherified or esterified; however, the crosslinking agents comprise at least two ethylenically unsaturated groups.

Examples of the parent alcohols are dihydric alcohols, such as 1,2-ethanediol, 1,2-propanediol, 1,3-propanediol, 1,2-butanediol, 1,3-butanediol, 2,3-butanediol, 1,4-butanediol, but-2-ene-1,4-diol, 1,2-pentanediol, 1,5-pentanediol, 1,2-hexanediol, 1,6-hexanediol, 1,10-decanediol, 1,2-dodecanediol, 1,12-dodecanediol, neopentylglycol, 3-methylpentane-1,5-diol, 2,5-dimethyl-1,3-hexanediol, 2,2,4-trimethyl-1,3-pentanediol, 1,2-cyclohexanediol, 1,4-cyclohexanediol, 1,4-bis(hydroxymethyl)cyclohexane, mononeopentylglycol hydroxypivalate, 2,2-bis(4-hydroxyphenyl)propane, 2,2-bis[4-(2-hydroxypropyl)phenyl]propane, diethylene glycol, triethylene glycol, tetraethylene glycol, dipropylene glycol, tripropylene glycol, tetrapropylene glycol, 3-thiapentane-1,5-diol and polyethylene glycols, polypropylene glycols and polytetrahydrofurans having molecular weights of in each case from 200 to 10 000. In addition to the homopolymers of ethylene oxide or propylene oxide, it is also possible to use block copolymers of ethylene oxide or propylene oxide or copolymers which comprise incorporated ethylene oxide and propylene oxide groups. Examples of parent alcohols having more than two OH groups are trimethylolpropane, glycerol, pentaerythritol, 1,2,5-pentanetriol, 1,2,6-hexanetriol, cyanuric acid, sorbitan, sugars, such as sucrose, glucose, mannose. Of course, the polyhydric alcohols can also be used after reaction with ethylene oxide or propylene oxide as the corresponding ethoxylates and propoxylates, respectively. The polyhydric alcohols can also first be converted into the corresponding glycidyl ethers by reaction with epichlorohydrin.

Further suitable crosslinking agents are the vinyl esters or the esters of monohydric, unsaturated alcohols with ethylenically unsaturated C₃-C₆-carboxylic acids, for example acrylic acid, methacrylic acid, itaconic acid, maleic acid or fumaric acid. Examples of such alcohols are allyl alcohol, 1-buten-3-ol, 5-hexen-1-ol, 1-octen-3-ol, 9-decen-1-ol, dicyclopentenyl alcohol, 10-undecen-1-ol, cinnamic alcohol, citronellol, crotyl alcohol or cis-9-octadecen-1-ol. However, it is also possible to esterify the monohydric, unsaturated alcohols with polybasic carboxylic acids, for example malonic acid, tartaric acid, trimellitic acid, phthalic acid, terephthalic acid, citric acid or succinic acid.

Further suitable crosslinking agents are esters of unsaturated carboxylic acids with the polyhydric alcohols described above, for example of oleic acid, crotonic acid, cinnamic acid or 10-undecenoic acid.

Other suitable crosslinking agents are straight-chain or branched, linear or cyclic, aliphatic or aromatic hydrocarbons which have at least two double bonds which, in the case of aliphatic hydrocarbons, are not permitted to be conjugated, e.g. divinylbenzene, divinyltoluene, 1,7-octadiene, 1,9-decadiene, 4-vinyl-1-cyclohexene or trivinylcyclohexane having molecular weights of from 200 to 20 000.

Further suitable crosslinking agents are the acrylamides, methacrylamides and N-allylamines of at least difunctional amines. Such amines are, for example, 1,2-diaminoethane, 1,3-diaminopropane, 1,4-diaminobutane, 1,6-diaminohexane, 1,12-dodecanediamine, piperazine, diethylenetriamine or isophoronediamine. Also suitable are the amides of allylamine and unsaturated carboxylic acids, such as acrylic acid, methacrylic acid, itaconic acid, maleic acid, or at least dibasic carboxylic acids, as have been described above.

Furthermore, triallylamine and triallylmonoalkylammonium salts, e.g. triallylmethylammonium chloride or methylsulfate, are suitable as crosslinking agents.

N-Vinyl compounds of urea derivatives, at least difunctional amides, cyanurates or urethanes, for example of urea, ethyleneurea, propyleneurea or tartaric acid diamide, e.g. N,N′-divinylethyleneurea or N,N′-divinylpropyleneurea, are also suitable.

Further suitable crosslinking agents are divinyldioxane, tetraallylsilane or tetravinylsilane. Of course, mixtures of the abovementioned compounds may also be used. Water-soluble crosslinking agents are preferably used.

Furthermore, the crosslinking monomers also include those which, in addition to an ethylenically unsaturated double bond, have a reactive functional group, for example an aldehyde group, a keto group or an oxirane group, which can react with an added crosslinking agent. The functional groups are preferably keto or aldehyde groups. The keto or aldehyde groups are preferably bound to the polymer by copolymerization of copolymerizable, ethylenically unsaturated compounds having keto or aldehyde groups. Suitable such compounds are acrolein, methacrolein, vinyl alkyl ketones having 1 to 20, preferably 1 to 10, carbon atoms in the alkyl radical, formylstyrene, alkyl (meth)acrylates having one or two keto or aldehyde groups or one aldehyde group and one keto group in the alkyl radical, the alkyl radical preferably comprising all together from 3 to 10 carbon atoms, e.g. (meth)acryloyloxyalkylpropanals, as described in DE-A-2722097. Furthermore, N-oxoalkyl(meth)acrylamides, as disclosed, for example, in U.S. Pat. No. 4,226,007, DE-A-2061213 or DE-A-2207209, are also suitable. Acetoacetyl (meth)acrylate, acetoacetoxyethyl (meth)acrylate and in particular diacetoneacrylamide are particularly preferred. The crosslinking agents are preferably a compound having at least two functional groups, in particular from two to five functional groups, which can undergo a crosslinking reaction with the functional groups of the polymer, especially the keto or aldehyde groups. These include, for example, hydrazide, hydroxylamine or oxime ether or amino groups as functional groups for the crosslinking of the keto or aldehyde groups. Suitable compounds having hydrazide groups are, for example, polycarboxylic acid hydrazides having a molecular weight of up to 500 g/mol. Particularly preferred hydrazide compounds are dicarboxylic acid dihydrazides having preferably 2 to 10 carbon atoms. These include, for example, oxalic acid dihydrazide, malonic acid dihydrazide, succinic acid dihydrazide, glutaric acid dihydrazide, adipic acid dihydrazide, sebacic acid dihydrazide, maleic acid dihydrazide, fumaric acid dihydrazide, itaconic acid dihydrazide and/or isophthalic acid dihydrazide. Of particular interest are: adipic acid dihydrazide, sebacic acid dihydrazide and isophthalic acid dihydrazide. Suitable compounds having hydroxylamine or oxime ether groups are mentioned, for example, in WO 93/25588.

Surface crosslinking can also additionally be produced by appropriate introduction of additives into the aqueous polymer dispersion (PD). This includes, for example, the addition of a photoinitiator or of a siccative. Suitable photoinitiators are those which are activated by sunlight, for example benzophenone or benzophenone derivatives. The metal compounds recommended for aqueous alkyd resins, for example based on Co or Mn, are suitable for the addition of siccatives (overview in U. Poth, Polyester and Alkydharze, Vincentz Network 2005, page 183 et seq.).

The crosslinking component is preferably used in an amount of from 0.0005 to 4.99% by weight, preferably from 0.001 to 2.5% by weight, in particular from 0.01 to 1.5% by weight, based on the total weight of the monomers used for the polymerization (including the crosslinking agent).

A specific embodiment relates to polymer dispersions (PD) which comprise no crosslinking agent incorporated in the form of polymerized units.

The free radical polymerization of the monomers (M1) and tert-butyl (meth)acrylate can be effected in the presence of at least one chain-transfer agent. Chain-transfer agents are preferably used in an amount of from 0.0005 to 5% by weight, particularly preferably from 0.001 to 2.5% by weight and in particular from 0.01 to 1.5% by weight, based on the total weight of the monomers used for the polymerization.

In general, compounds having high transfer constants are designated as chain-transfer agents (polymerization chain-transfer agents). Chain-transfer agents accelerate chain-transfer reactions and therefore result in a reduction in the degree of polymerization of the resulting polymers. In the case of the chain-transfer agents, a distinction may be made among mono-, bi- and polyfunctional chain-transfer agents, depending on the number of functional groups in the molecule which can lead to one or more chain-transfer reactions. Suitable chain-transfer agents are described in detail, for example, by K. C. Berger and G. Brandrup in J. Brandrup, E. H. Immergut, Polymer Handbook, 3rd edition, John Wiley & Sons, New York, 1989, pages II/81-II/141.

Suitable chain-transfer agents are, for example, aldehydes, such as formaldehyde, acetaldehyde, propionaldehyde, n-butyraldehyde and isobutyraldehyde.

Furthermore, the following may also be used as chain-transfer agents: formic acid, its salts or esters, such as ammonium formate, 2,5-diphenyl-1-hexene, hydroxylammonium sulfate, and hydroxylammonium phosphate.

Further suitable chain-transfer agents are allyl compounds, such as, for example, allyl alcohol, cyclopentadiene, dicyclopentadiene, terpineols, functionalized allyl ethers, such as allyl ethoxylates, alkyl allyl ethers or glyceryl monoallyl ether.

Preferably used chain-transfer agents are compounds which comprise sulfur or phosphorus in bound form.

Compounds of this type are, for example, inorganic hydrogen sulfites, disulfites and dithionites or organic sulfides, disulfides, polysulfides, sulfoxides and sulfones. These include di-n-butyl sulfide, di-n-octyl sulfide, diphenyl sulfide, thiodiglycol, ethylthioethanol, diisopropyl disulfide, di-n-butyl disulfide, di-n-hexyl disulfide, diacetyl disulfide, diethanol sulfide, di-t-butyl trisulfide, dimethyl sulfoxide, dialkyl sulfide, dialkyl disulfide and/or diaryl sulfide.

Thiols (compounds which comprise sulfur in the form of SH groups, also referred to as mercaptans) are furthermore suitable as polymerization chain-transfer agents. Mono-, bi- and polyfunctional mercaptans, mercaptoalcohols and/or mercaptocarboxylic acids are preferred as chain-transfer agents. Examples of these compounds are allyl thioglycolates, ethyl thioglycolate, cysteine, 2-mercaptoethanol, 1,3-mercaptopropanol, 3-mercaptopropane-1,2-diol, 1,4-mercaptobutanol, mercaptoacetic acid, 3-mercaptopropionic acid, mercaptosuccinic acid, thioglycerol, thioacetic acid, thiourea and alkyl mercaptans, such as n-butyl mercaptan, n-hexyl mercaptan or n-dodecyl mercaptan, tert-dodecyl mercaptan and isomer mixtures thereof. Useful phosphorus-containing regulators have been found to be hypophosphorous acid and salts or esters thereof.

Examples of bifunctional chain-transfer agents which comprise two sulfur atoms in bound form are bifunctional thiols, such as, for example, dimercaptopropanesulfonic acid (sodium salt), dimercaptosuccinic acid, dimercapto-1-propanol, dimercaptoethane, dimercaptopropane, dimercaptobutane, dimercaptopentane, dimercaptohexane, ethylene glycol bisthioglycolates and butanediol bisthioglycolate. Examples of polyfunctional chain-transfer agents are compounds which comprise more than two sulfur atoms in bound form. Examples of these are trifunctional and/or tetrafunctional mercaptans.

All chain-transfer agents mentioned can be used individually or in combination with one another. A specific embodiment relates to the use according to the invention of polymers (P) which are prepared by free radical emulsion polymerization without addition of a chain-transfer agent.

For the preparation of the polymers (P), the monomers are polymerized with the aid of free radical initiators.

The peroxo and/or azo compounds customary for free radical polymerization can be used as initiators for this purpose, for example alkali metal or ammonium peroxodisulfates, diacetyl peroxide, dibenzoyl peroxide, succinyl peroxide, di-tert-butyl peroxide, hydrogen peroxide, tert-butyl perbenzoate, tert-butyl perpivalate, tert-butyl peroxy-2-ethylhexanoate, tert-butyl permaleate, cumyl hydroperoxide, diisopropyl peroxodicarbamate, bis(o-toluoyl) peroxide, didecanoyl peroxide, dioctanoyl peroxide, dilauroyl peroxide, tert-butyl perisobutyrate, tert-butyl peracetate, di-tert-amyl peroxide, tert-butyl hydroperoxide, azobisisobutyronitrile, 2,2′-azobis(2-amidinopropane) dihydrochloride or 2,2′-azobis(2-methylbutyronitrile). Mixtures of these initiators are also suitable.

Reduction/oxidation (=redox) initiator systems can also be used as initiators. The redox initiator systems consist of at least one generally inorganic reducing agent and one inorganic or organic oxidizing agent. The oxidizing component comprises, for example, the initiators already mentioned above for the emulsion polymerization. The reducing component comprises, for example, alkali metal salts of sulfurous acid, such as, for example, sodium sulfite, sodium hydrogen sulfite, alkali metal salts of disulfurous acid, such as sodium disulfite, bisulfite addition compounds of aliphatic aldehydes and ketones, such as acetone bisulfite, or reducing agents such as hydroxymethanesulfinic acid and salts thereof, or ascorbic acid. The redox initiator systems can be used with the concomitant use of soluble metal compounds whose metallic component may occur in a plurality of valency states. Customary redox initiator systems are, for example, ascorbic acid/iron(II) sulfate/sodium peroxodisulfate, tert-butyl hydroperoxide/sodium disulfite, tert-butyl hydroperoxide/sodium hydroxymethanesulfinate. The individual components, for example the reducing component, may also be mixtures, for example a mixture of the sodium salt of hydroxymethanesulfinic acid and sodium disulfite.

The amount of the initiators is in general from 0.1 to 5% by weight, preferably from 0.1 to 2% by weight, based on all monomers to be polymerized. It is also possible to use a plurality of different initiators simultaneously or successively in the emulsion polymerization.

The preparation of the polymers (P) used according to the invention is usually effected in the presence of at least one surface-active compound. In particular, protective colloids as described, for example, in Houben-Weyl, Methoden der organischen Chemie, volume XIV/1, Makromolekulare Stoffe, Georg Thieme Verlag, Stuttgart, 1961, pages 411 to 420, and emulsifiers as described, for example, in Houben-Weyl, Methoden der organischen Chemie, volume 14/1, Makromolekulare Stoffe, Georg Thieme Verlag, Stuttgart, 1961, pages 192 to 208, are suitable for this purpose, in addition to the abovementioned emulsifiers (E).

Anionic and nonionic emulsifiers are suitable as emulsifiers (E) used. Emulsifiers whose relative molecular weights are usually below those of protective colloids are preferably used as surface-active substances. Cationic emulsifiers may also be used, but are not preferred. A mixture of nonionic and anionic emulsifiers is preferably used.

Suitable nonionic emulsifiers are arylaliphatic or aliphatic nonionic emulsifiers, for example ethoxylated mono-, di- and trialkylphenols (degree of ethoxylation: 3 to 50, alkyl radical: C₄-C₁₀), ethoxylates of long-chain alcohols (degree of ethoxylation: 3 to 100, alkyl radical: C₈-C₃₆) and polyethylene oxide/polypropylene oxide homo- and copolymers. These can comprise the alkylene oxide units incorporated in the form of polymerized units in random distribution or in the form of blocks. For example, ethylene oxide/propylene oxide block copolymers are very suitable. Ethoxylates of long-chain alkanols (alkyl radical C₁-C₃₀, average degree of ethoxylation 5 to 100) are preferably used and among these those having a linear C₁₂-C₂₀-alkyl radical and an average degree of ethoxylation of from 10 to 50 and ethoxylated monoalkylphenols are particularly preferably used.

Suitable anionic emulsifiers are, for example, alkali metal and ammonium salts of alkyl sulfates (alkyl radical: C₈-C₂₂), of sulfuric acid monoesters of ethoxylated alkanols (degree of ethoxylation: 2 to 50, alkyl radical: C₁₂-C₁₈) and of ethoxylated alkylphenols (degree of ethoxylation: 3 to 50, alkyl radical: C₄-C₈), of alkylsulfonic acids (alkyl radical: C₁₂-C₁₈) and of alkylarylsulfonic acids (alkyl radical: C₉-C₁₈). Further suitable emulsifiers are to be found in Houben-Weyl, Methoden der organischen Chemie, volume XIV/1, Makromolekulare Stoffe, Georg-Thieme-Verlag, Stuttgart, 1961, pages 192-208). Sulfosuccinic esters or monoesters or amides with C₅-C₁₂ alkyl or cycloalkyl groups in the side chain, or else bis(phenylsulfonic acid) ethers or the alkali metal or ammonium salts thereof which carry a C₄-C₂₄-alkyl group on one or both aromatic rings are also suitable as further anionic emulsifiers. These compounds are generally known, for example from U.S. Pat. No. 4,269,749, and are commercially available, for example as Dowfax® 2A1 (Dow Chemical Company).

Suitable cationic emulsifiers are preferably quaternary ammonium halides, e.g. trimethylcetylammonium chloride, methyltrioctylammonium chloride, benzyltriethyl-ammonium chloride, or quaternary compounds of N—C₆-C₂₀-alkylpyridines, -morpholines or -imidazoles, e.g. N-laurylpyridinium chloride.

If the preparation of the polymers (P) is effected in the presence of at least one surface-active compound, this is generally used in an amount of from about 0.01 to 10% by weight, preferably from 0.1 to 5% by weight, very preferably in an amount of from 1 to 3%, based on the amount of monomers to be polymerized.

The polymerization is generally effected at temperatures in a range from 0 to 150° C., preferably from 20 to 100° C., particularly preferably from 30 to 95° C. The polymerization is preferably effected at atmospheric pressure, but a polymerization under superatmospheric pressure, for example the autogenous pressure of the components used for the polymerization, is also possible. In a suitable embodiment, the polymerization is effected in the presence of at least one inert gas, such as, for example, nitrogen or argon.

The polymerization medium may consist either only of water or of mixtures of water and liquids miscible therewith, such as methanol. Preferably, only water is used. The emulsion polymerization can be carried out either as a batch process or in the form of a feed process, including step or gradient procedure. The feed process in which a part of the polymerization batch and/or polymer seed is initially taken, heated to the polymerization temperature, mixed with polymerization initiator and prepolymerized and then the remainder of the polymerization batch is fed with cooling to the polymerization zone, usually via a plurality of spatially separated feeds, one or more of which comprise the monomers in pure or in emulsified form, continuously, stepwise or with superimposition of a concentration gradient, while maintaining the polymerization is preferred.

The manner in which the initiator is added to the polymerization vessel in the course of the free radical aqueous emulsion polymerization is known to the average person skilled in the art. It can either be completely initially taken in the polymerization vessel or used continuously or stepwise at the rate of consumption in the course of the free radical aqueous emulsion polymerization. Specifically, this depends on the chemical nature of the initiator system and on the polymerization temperature. Preferably, a part is initially taken and the remainder is fed at the rate of consumption.

The dispersions formed during the polymerization can be subjected to a physical or chemical aftertreatment after the polymerization process. Such methods are, for example, the known methods for residual monomer reduction, such as, for example, the aftertreatment by addition of polymerization initiators or mixtures of a plurality of polymerization initiators at suitable temperatures, an aftertreatment of the polymer solution by means of steam or ammonia vapor, or stripping with inert gas or treatment of the reaction mixture with oxidizing or reducing agents, adsorption methods, such as the adsorption of impurities on selected media, such as, for example, active carbon, or ultrafiltration.

Preferably, the polymers (P) used according to the invention have a weight average molecular weight M_{w} in the range from about 1000 to 2 000 000, preferably from 1500 to 1 000 000 and in particular from 2000 to 500 000. The molar mass determination can be effected by gel permeation chromatography using a standard, such as polymethyl methacrylate.

The glass transition temperature T_{g} of the polymers (P) used according to the invention is preferably between −50° C. and 100° C., particularly preferably between −20° C. and 70° C., in particular between −5° C. and 60° C.

Furthermore, customary assistants and additives may be added to the polymer dispersions according to the invention. These include, for example, pH-adjusting substances, reducing agents and bleaches, such as, for example, the alkali metal salts of hydroxymethanesulfinic acid (e.g. Rongalit® C from BASF Aktiengesellschaft), complexing agents, deodorants, flavorings, odorous substances and viscosity modifiers, such as alcohols, e.g. glycerol, methanol, ethanol, tert-butanol, glycol, etc. These assistants and additives can be added to the polymer dispersions in the initially taken mixture, in one of the feeds or after the end of the polymerization.

The aqueous polymer dispersion usually has a solids content of from 20 to 70% by weight, preferably from 35 to 65% by weight.

Through their use in construction adhesives, filling compounds, renders and paints, these polymer dispersions used according to the invention are suitable for improving the fire behavior of the renders, paints, construction adhesives or filling compounds produced therefrom. The composition is selected such that the dispersions are compatible with the additives in the formulations, such as fillers, pigments, solvents and rheology modifiers.

Regarding preferred embodiments of the polymer dispersions according to the invention, reference is made to the statements made beforehand in relation to the use according to the invention, in their entirety.

The monomer composition used for providing the polymers (P) by free radical emulsion polymerization can, according to the invention, comprise up to 4.99% by weight of further monomers, based on the total weight of the monomers used for the emulsion polymerization, in addition to the monomers (M1) and tert-butyl (meth)acrylate. Suitable further monomers are in particular the monomers mentioned above in the context of the use as further suitable monomers (M1) and those mentioned above as crosslinking agents. Usually, however, the proportion of the monomer composition used for the free radical emulsion polymerization will not exceed 3% by weight, preferably 1% by weight and particularly preferably 0.1% by weight of further monomers.

In a specific embodiment of the present invention, the proportions of monomers (M1) and tert-butyl (meth)acrylate in the monomer composition used for the free radical emulsion polymerization sum to 100% by weight, based on the total weight of the monomers used for the emulsion polymerization, i.e. the polymers (P) comprise no further monomers incorporated in the form of polymerized units, apart from the monomers (M1) and tert-butyl (meth)acrylate.

The polymer (P) present in the polymer dispersion according to the invention is preferably obtainable by an emulsion polymerization in which at least a part of the monomers (M1) is selected from esters of α,β-ethylenically unsaturated mono- and dicarboxylic acids with C₁-C₈-alkanols. Regarding further preferred meanings and amounts of the monomers (M1) in the polymer dispersions (PD) according to the invention, reference is made to the above statements in their entirety.

The polymer dispersions according to the invention which are described above can be used as such or after mixing with further, as a rule film-forming polymers as a binder composition in construction adhesives, filling compounds and renders, such as high-filler, purely polymer-bound renders, lime and cement renders having a polymer content, silicate renders having a polymer content, but also special renders, and in water-based paints, such as paint or finish mixtures.

The polymer dispersions according to the invention are preferably used in renders and water-based paints. These paints are present, for example, in the form of an unpigmented system (clearcoat) or a pigmented system. The proportion of the pigments can be described by the pigment volume concentration (PVC). The PVC describes the ratio of the volume of pigments (V_{P}) and fillers (V_{F}) to the total volume, consisting of the volumes of binder (V_{B}), pigments and fillers of a dried coating film in percent: PVC=(V_{P}+V_{F})×100/(V_{P}+V_{F}+V_{B}); cf. Ullmann's Enzyklopädie der technischen Chemie, 4th edition, volume 15, page 667. Paints can be classified on the basis of the PVC, for example, as follows:

| high-filler interior paint, wash-resistant, abrasion | about 80-85 |
|---|---|
| class 3 (DIN EN 13300), white/matt | |
| interior paint, abrasion-resistant, abrasion class 2 | about 70-80 |
| (DIN EN 13300) white/matt | |
| semi-gloss paint, silk matt | about 35-45 |
| semi-gloss paint, silk gloss (latex paint) | about 25-35 |
| high-gloss paint | about 15-25 |
| exterior masonry paint, white | about 40-70 |
| clearcoat/clear varnish | 0 |

An embodiment of the present invention relates to paints in the form of a clearcoat. A further embodiment of the present invention comprises paints in the form of an emulsion paint.

The invention furthermore relates to a paint in the form of an aqueous composition comprising:
at least one polymer dispersion as defined above,
at least one inorganic filler and/or at least one inorganic pigment,
at least one customary assistant and
water.

A paint comprising:
from 5 to 60% by weight of at least one polymer dispersion as defined above,
from 10 to 70% by weight of inorganic fillers and/or inorganic pigments,
from 0.1 to 20% by weight of customary assistants and
water to 100% by weight
   is preferred.

Below, the composition of a customary emulsion paint is explained. Emulsion paints comprise as a rule from 30 to 75% by weight and preferably from 40 to 65% by weight of nonvolatile constituents. These are understood as meaning all constituents of the formulation which are not water, but at least the total weight of binder, filler, pigment, sparingly volatile solvents (boiling point above 220° C.), e.g. plasticizer, and polymeric assistants. Among these, about
a) from 3 to 90% by weight, in particular from 10 to 60% by weight, are accounted for by the polymer dispersion according to the invention,
b) from 0 to 85% by weight, preferably from 5 to 60% by weight, in particular from 10 to 50% by weight, are accounted for by at least one inorganic pigment,
c) from 0 to 85% by weight, in particular from 5 to 60% by weight, are accounted for by inorganic fillers and
d) from 0.1 to 40% by weight, in particular from 0.5 to 20% by weight, are accounted for by customary assistants.

The polymer dispersions according to the invention for the production of masonry paints having a PVC in the range from 40 to 70 or interior paints having a PVC in the range from 70 to 85 are particularly suitable.

In the context of this invention, all pigments and fillers together, e.g. colored pigments, white pigments and inorganic fillers, are designated as pigment. These include inorganic white pigments, such as titanium dioxide, preferably in the rutile form, barium sulfate, zinc oxide, zinc sulfide, basic lead carbonate, antimony trioxide, lithopone (zinc sulfide+barium sulfate), or colored pigments, for example iron oxides, carbon black, graphite, zinc yellow, zinc green, ultramarine, manganese black, antimony black, manganese violet, Paris blue, or Paris green. In addition to the inorganic pigments, the emulsion paints according to the invention may also comprise organic colored pigments, e.g. sepia, gamboge, Cassel brown, toluidine red, paranitraniline red, Hansa yellow, indigo, azo dyes, anthraquinoid and indigoid dyes and dioxazine, quinacridone, phthalocyanine, isoindolinone and metal complex pigments. Synthetic organic white pigments having air inclusions for increasing the light scattering, such as the Rhopaque® dispersions, are also suitable.

Suitable fillers are, for example, aluminosilicates, such as feldspars, silicates, such as kaolin, talc, mica, magnesite, alkaline earth metal carbonates, such as calcium carbonate, for example in the form of calcite or chalk, magnesium carbonate, dolomite, alkaline earth metal sulfates, such as calcium sulfate, silicon dioxide, etc. Of course, finely divided fillers are preferred in paints. The fillers can be used as individual components. In practice, however, filler mixtures have proven particularly useful, for example calcium carbonate/kaolin, calcium carbonate/talc. Gloss paints have as a rule only small amounts of very finely divided fillers or comprise no fillers.

Finely divided fillers can also be used for increasing the hiding power and/or for saving white pigments. Mixtures of colored pigments and fillers are preferably used for adjusting the hiding power, the hue and the depth of color.

The coating material according to the invention (water-based paints) may comprise further assistants in addition to the polymer dispersion (PD), optionally additional film-forming polymers and pigment.

In addition to the emulsifiers used in the polymerization, the customary assistants include wetting agents or dispersants, such as sodium, potassium or ammonium polyphosphates, alkali metal and ammonium salts of acrylic or maleic anhydride copolymers, polyphosphonates, such as sodium 1-hydroxyethane-1,1-diphosphonate, and naphthalenesulfonic acid salts, in particular the sodium salts thereof.

Further suitable assistants are leveling agents, antifoams, biocides and thickeners. Suitable thickeners are, for example, cellulose thickeners, xanthanes, acrylate thickeners and associative thickeners, such as polyurethane thickeners. The amount of the thickener is preferably less than 2% by weight, particularly preferably less than 1% by weight, based on the solids content of the paint, in order to avoid very greatly reducing the water resistance of the render or of the paint.

For improving the fire behavior, so-called flameproofing agents can also be added to the paints and renders. These may be halogenated flameproofing agents, such as polybrominated diphenyl ethers, polybrominated biphenyls or, for example, chloroparaffins or mirex, or nitrogen-based flameproofing agents, such as melamine or urea, or organophosphorus flameproofing agents, such as tris(chloroethyl) phosphate, tricresyl phosphate, resorcinol bis(diphenylphosphate), or inorganic flameproofing agents, such as aluminum hydroxide, magnesium hydroxide, ammonium sulfate, aluminum phosphate, antimony trioxide, zinc borates or slaked lime.

The preparation of the paints according to the invention is effected in a known manner by mixing the components in mixing apparatuses customary for this purpose. It has proven useful to prepare an aqueous paste or dispersion from the pigments, water and optionally the assistants and only thereafter to mix the polymeric binder, i.e. as a rule the aqueous dispersion of the polymer, with the pigment paste or pigment dispersion. For the achievement of high solids, the dispersion in dilute form can also be used during the production of the pigment paste.

The paints according to the invention comprise as a rule from 30 to 75% by weight and preferably from 40 to 65% by weight of nonvolatile constituents. These are to be understood as meaning all constituents of the formulation which are not water, but at least the total amount of binder, pigment and assistant, based on the solids content of the paint.

The volatile constituents are predominantly water.

The paint according to the invention can be applied to substrates in a customary manner, for example by spreading, spraying, immersion, roll-coating, knife-coating.

It is preferably used as building paint, i.e. for coating buildings or parts of buildings. These may be mineral substrates, such as renders, plasterboards or sandwich-type plasterboards, masonry or concrete, or may be wood, wood-based materials, metal or paper, e.g. wallpaper, or plastic, i.e. PVC.

The paint is preferably used for interior parts of buildings, e.g. interior walls, interior doors, paneling, banisters, furniture, etc.

The paints according to the invention are distinguished by easy handling, good processing properties and high hiding power. The paints have a low level of pollutants. They have good performance characteristics, for example, good water resistance, good soiling resistance, water resistance and vegetation resistance. The working apparatus used can be easily cleaned with water.

In addition, the coats produced from the paints according to the invention generally have a low proportion of volatile organic compounds.

In particular, however, the paints according to the invention and coats are distinguished by improved fire behavior.

Renders are a coating for interior and exterior walls, generally applied in a plurality of layers and with a large layer thickness (several millimeters). The render is applied for smoothing or providing a more attractive appearance and, in the case of exterior application, for protecting the surface from moisture.

Synthetic resin renders consist of a polymer dispersion as a binder and generally coarse fillers (up to max. 15 mm). They are used exclusively as decorative finish coats in the interior and exterior area. The drying is effected physically, and the binder adhesively bonds with various ingredients and produces the adhesion to the surface. The advantages of the synthetic resin renders are good adhesion on many surfaces, little susceptibility to cracking, tightness with respect to driving rain and water vapor permeability.

In the composition, the classical synthetic resin renders available on the market are very similar to one another. In addition to the classical synthetic resin renders, there is also a number of renders having specific properties:

Silicone Resin Renders:

In addition to the polymer dispersion, they comprise a silicone resin as a binder and give coatings having very high water vapor permeability and little sensitivity to rain.

Silicate Renders:

In addition to the (mineral) binder, waterglass, they comprise up to 5% by weight of polymer dispersion for stabilization. Silicate renders are classified between pure synthetic resin renders and mineral renders. They also have high water vapor permeability but also a high water permeability, which must be reduced by suitable measures, for example imparting a water repellency.

Of course, the choice of the constituents of the formulation (binders, additives, fillers) influences the material behavior, for example the water absorption of the render.

Depending on the type and coarsest filler used, synthetic resin renders must, as the following list (according to DIN 18558) shows, comprise minimum amounts of binder:

| | | |
|---|---|---|
| | | Proportion of binder |
| | Max. particle | [solid, based on total solids |
| Type | size [mm] | content, % by weight] |

Exterior and interior render:

| | | |
|---|---|---|
| P Org. I | <=1 | 8 |
| P Org. I | >1 | 7 |

Only interior render:

| | | |
|---|---|---|
| P Org. 2 | <=1 | 5.5 |
| P Org. 2 | >1 | 4.5 |

The following processing properties for renders are important:

Surface processing with as little application of force as possible,
no smearing or sagging of the render,
sufficiently long open time for avoiding application points.

The processing properties can be influenced mainly by assistants, such as, for example, for modifying the rheological features. The binder plays only a minor role here.

The variety of the surface effects achievable with synthetic resin renders is determined firstly by the particle composition and secondly by the application method.

A considerable proportion of the synthetic resin renders is used today, predominantly in the exterior area, in composite heat insulation systems (CHIS). The following types are known:

brushable render,
roller-applied render,
sprayed render,
rough cast,
float-applied render,
grooved render,
modeling render and
variegated stone/natural stone render.

Brushable, roller-applied and sprayed renders derive their names from the respective method of application and comprise no coarse fillers. If finishing of the surface is appropriate, the term modeling render is used.

Rough casts comprise equal proportions of aggregates of very different grain sizes. On drying, the large grains are clearly evident (through volume shrinkage). The result is a surface which resembles that of a mineral rough cast.

Float-applied and grooved renders comprise a small proportion of particles having a substantially larger grain, which leave behind groove-like tracks in the surface on smoothing (“sanding”). Depending on the method of smoothing, a multiplicity of round or straight structures can be obtained.

A considerable proportion of the synthetic resin renders is used today, predominantly in the exterior area, in CHIS. A CHIS system consists of:

adhesive layer,
heat insulation board,
filling compound with embedded reinforcement and
finish coat.

The adhesive must ensure the contact of the heat insulation with the surface and therefore adhere well to both components. The heat insulation (generally mineral fiber boards or boards comprising Styropor®) is the actual centerpiece of the CHIS. It must have a low thermal conductivity and sufficient tensile strength and be non-rotable. On a critical surface, it is additionally fastened with special dowel pins. The adhesive is almost always used as a binder for the filling compound. The reinforcement, which compensates the mechanical and thermal stresses between the surface and the insulation boards and the covering layer is inserted into the material.

This layer must have in particular a high tensile strength in combination with low extension. In general, glass fiber fabrics are used therein; plastics fabrics are not suitable owing to their thermoplasticity. The finish coat should be resilient to a certain degree, but in principle a standard synthetic resin render is suitable for this purpose. The render processing has to meet the customary requirements.

The invention furthermore relates to renders comprising
at least one polymer dispersion as defined above
at least one wetting agent or dispersant
at least one inorganic pigment and/or at least one inorganic filler
further customary assistants such as preservatives, antifoams, thickeners, film-forming assistants or water repellents.

The choice of the thickener is very critical for the processing properties of the render. Thus, a polymer containing carboxyl groups, such as Latekoll®, ensures sufficient wet adhesion and permits absolutely smear-free work during subsequent sanding.

The various cellulose ethers, too, influence the processing properties. Methyl- or hydroxyethylcellulose permit good wet adhesion, but smearing of the render can easily occur. Methylhydroxypropylcellulose permits good wet adhesion without smearing. The choice of antifoam is likewise very important. In the case of variegated stone renders, a certain degree of foam formation may of course even be desirable for achieving a pliable, readily processible render.

Possible further additives: glycol (not more than 2%) helps to increase the frost resistance in the container. Larger additions of glycol, however, reduce the viscosity. Plasticizers, e.g. Plastilit® 3060, serve for making the render flexible. In the case of such additions, it must be taken into account that they influence the drying and, in the case of a boiling point of <250° C., have to date to be classified as VOC. Surface-active substances, such as emulsifiers, improve the processing properties.

The production of such renders is effected today in general in horizontal positive mixers. Since both a very high solids content and high viscosity are to be achieved, it is necessary to initially take the dispersion. All additives and finally the fillers are then added to it.

The invention furthermore relates to a composite heat insulation system (CHIS) comprising
at least one polymer dispersion as defined above,
an adhesive layer
a heat insulation board
a filling compound with embedded reinforcement
a finish coat and
further customary assistants.

The invention is explained in detail with reference to the following examples to be interpreted as being non-limiting.

### EXAMPLE DISPERSIONS

### Preparation of the Standard Dispersion=n-BA/MMA Copolymer (49.2/48.0% by Weight) (Example A)

A mixture of 231.09 g of water, 4.50 g of a 20% strength aqueous solution of arylsulfonate, 0.12 g of copper(II) sulfate and 30.30 g of feed 1 was initially taken in a tank equipped with stirrer, thermometer, reflux condenser and feed vessels. Feed 1 consisted of 244.14 g of water, 8.0 g of a 45% strength aqueous solution of dodecyldiphenyl ether disulfonic acid sodium salt, 12.0 g of a 20% strength aqueous solution of a C₁₆-C₁₈-fatty alcohol polyethoxylate (18 EO), 7.80 g of acrylic acid, 18.0 g of acrylamide (50% strength), 295.20 g of n-butyl acrylate and 288.0 g of methyl methacrylate.

The initially taken mixture was heated to 90° C. with stirring. Thereafter, 3.43 g of a 7% strength aqueous solution of sodium peroxodisulfate were added while maintaining this temperature and stirring was effected for 5 min. Thereafter, feed 1 was metered in in 180 min and simultaneously therewith 15.43 g of a 7% strength aqueous solution of sodium peroxodisulfate in 180 min.

After the end of feed 1, stirring was effected for a further 15 min and neutralization was effected with 13.08 g of sodium hydroxide solution (6.5% strength aqueous solution). Thereafter, 9.06 g of tert-butyl hydroperoxide (4% strength aqueous solution) and 13.16 g of acetone bisulfite (4.6% strength aqueous solution) were metered in 60 min. After the end of the additions, 34.97 g of water were added.

Thereafter, the dispersion was cooled, neutralized with 20.88 g of sodium hydroxide solution (4.9% strength aqueous solution) and filtered over a 125 μm filter. 1.22 kg of a 50% strength coagulate-free dispersion were obtained. The physical data for the dispersion are listed in Table 2.

### Preparation of the Comparative Dispersions B, C and D

Three comparative dispersions were prepared:

| | | |
|---|---|---|
| n-BA/styrene variant | (56/41.2% by weight) | example B |
| EHA/MMA variant | (49/48.2% by weight) | example C |
| EHA/styrene variant | (44/53.2% by weight) | example D |

Example B was prepared as follows.

A mixture of 338.4 g of water, 3 g of a 20% strength aqueous solution of arylsulfonate, 0.12 g of copper(II) sulfate and 37.11 g of feed 1 was initially taken in a tank equipped with stirrer, thermometer, reflux condenser and feed vessels. Feed 1 consisted of 440.40 g of water, 8.0 g of a 45% strength aqueous solution of dodecyldiphenyl ether disulfonic acid sodium salt, 12.0 g of a 20% strength aqueous solution of a C₁₆-C₁₈-fatty alcohol polyethoxylate, (18EO), 7.80 g of acrylic acid, 18.0 g of acrylamide (50% strength), 336.0 g of n-butyl acrylate and 247.2 g of styrene.

The initially taken mixture was heated to 95° C. with stirring. Thereafter, 10.06 g of a 2.4% strength aqueous solution of sodium peroxodisulfate were added while maintaining this temperature and stirring was effected for 5 min. Thereafter, feed 1 was metered in 150 min and simultaneously therewith 18.72 g of a 2.6% strength aqueous solution of sodium peroxodisulfate were metered in 150 min.

At the end of feeds 1 and 2, 8.57 g of a 7% strength aqueous solution of sodium peroxodisulfate were added. Thereafter, stirring was effected for a further 45 min and neutralization was effected with 12.6 g of ammonia (4.8% strength aqueous solution). Thereafter, 9.08 g of tert-butyl hydroperoxide (4% strength aqueous solution) and 13.15 g of acetone bisulfite (4.6% strength aqueous solution) were metered in 60 min. After the end of the additions, 34.97 g of water were added.

Thereafter, the dispersion was cooled, neutralized with 12.54 g of sodium hydroxide solution (8.1% strength aqueous solution) and filtered over a 125 μm filter. 1.53 kg of a 40% strength dispersion were obtained.

Examples C and D were prepared in the same way as example B. For example C, feed 1 was prepared with 289.2 g of methyl methacrylate and 294 g of ethylhexyl acrylate. In example D, feed 1 was prepared with 264 g of ethylhexyl acrylate and 319.2 g of styrene.

### Preparation of Tert-Butyl Acrylate-Containing Dispersions (Examples E to J, L, M, O to R, T and U)

On the basis of the standard dispersion (example A), various t-BA-containing dispersions were prepared. The glass transition temperature was varied from 0 to 40° C.
n-BA/MMA/t-BA variant→with 30-70% by weight of t-BA
n-BA/styrene/t-BA variant→with 30% by weight of t-BA
n-BA/t-BA/VAc variant→with 45-55% by weight of t-BA & 14-20% by weight of VAc
n-BA/MMA/t-BA/VAc→with 30-35% by weight of t-BA & 14-15% by weight of VAc
n-BA/EA/t-BA/VAc→with 49% by weight of t-BA & 20% by weight of VAc
n-BA/MMA/t-BA/EA→with 35% by weight of t-BA
n-BA=n-butyl acrylate
MMA=methyl methacrylate
t-BA=tert-butyl acrylate
VAc=vinyl acetate
EA=ethyl acetate

TABLE 1
Composition of Examples E to O

| | | t-BA | n-BA | MMA | S | VAc | EA |
|---|---|---|---|---|---|---|---|
| Sample | Description | (g) | (g) | (g) | (g) | (g) | (g) |
| E | t-BA (50%)/n-BA (37.2%)/MMA (10%) | 300 | 223.2 | 60 | | | |
| F | t-BA (30%)/n-BA (40.8%)/MMA (26.4%) | 180 | 244.8 | 158.4 | | | |
| G | t-BA (30%)/n-BA (41%)/S (26.2%) | 180 | 246 | | 157.2 | | |
| H | t-BA (45%)/n-BA (32.2%)/VAc (20%) | 270 | 193.2 | | | 120 | |
| I | t-BA (50%)/n-BA (32.9%)/VAc (14.3%) | 300 | 197.4 | | | 85.8 | |
| J | t-BA (30%)/n-BA (36.4%)/MMA (16.8%)/VAc (14%) | 180 | 218.4 | 100.8 | | 84 | |
| L | t-BA (35%)/n-BA (30.7%)/MMA (31.5%) | 210 | 184.2 | 189 | | | |
| M | t-BA (49%)/n-BA (8.2%)/EA (20%)/VAc (20%) | 294 | 49.2 | | | 120 | 120 |
| O | t-BA (35%)/n-BA (17.6%)/MMA (24.6%)/EA (20%) | 210 | 105.6 | 147.6 | | | 120 |
| P | t-BA (30%)/n-BA (38.4%)/MMA (28.8%) | 180 | 230.4 | 172.8 | | | |
| Q | t-BA (35%)/n-BA (37.2%)/MMA (25%) | 210 | 223.2 | 150 | | | |
| R | t-BA (55%)/n-BA (27.9%)/VAc (14.3%) | 330 | 167.4 | | | 85.8 | |
| T | t-BA (35%)/n-BA (27.2%)/MMA (20%)/EA (15%) | 210 | 163.2 | 120 | | | 90 |
| U | t-BA (35%)/n-BA (23.7%)/MMA (18.5%)/EA (20%) | 210 | 142.2 | 111 | | | 120 |

### Preparation of Tert-Butyl Methacrylate-Containing Dispersion (Example K)

On the basis of the comparative dispersion, a t-BMA-containing dispersion was prepared: t-BMA/nBA variant with the composition 48 and 49.2% by weight of the main monomer, which means that for this example feed 1 was prepared with 288 g of tert-butyl methacrylate and 295.2 g of n-butyl acrylate.

### Preparation of the Tert-Butyl Acrylate-Containing Dispersion in Example N

On the basis of the standard dispersion, a t-BA-containing dispersion (example N) was prepared in a two-stage method.

A mixture of 231.09 g of water, 4.50 g of a 20% strength aqueous solution of arylsulfonate, 0.12 g of copper(II) sulfate and 15.21 g of feed 1 was initially taken in a tank equipped with stirrer, thermometer, reflux condenser and feed vessels. Feed 1 consisted of 83 g of water, 4.0 g of a 45% strength solution of dodecyldiphenyl ether disulfonic acid sodium salt, 6.0 g of a 20% strength aqueous solution of a C₁₆C₁₈-fatty alcohol polyethoxylate (18EO), 3.90 g of acrylic acid, 9.0 g of acrylamide (50% strength), 97.50 g of n-butyl acrylate, 105.0 g of tert-butyl methacrylate, 90.0 g of vinyl acetate and 40 g of a 3% strength aqueous solution of sodium pyrophosphate.

The initially taken mixture was heated to 90° C. with stirring. Thereafter, 3.43 g of a 7% strength aqueous solution of sodium peroxodisulfate were added while maintaining this temperature and stirring was effected for 5 min. Thereafter, feed 1 was metered in in 75 min and, simultaneously therewith 36.86 g of a 7% strength aqueous solution of sodium peroxodisulfate were metered in in 180 min. After the end of feed 1, feed 2 was metered in directly in 75 min. Feed 2 consisted of 83.3 g of water, 4.0 g of a 45% strength aqueous solution of dodecyldiphenyl ether disulfonic acid sodium salt, 6.0 g of a 20% strength aqueous solution of a C₁₆-C₁₈-fatty alcohol polyethoxylate (18EO), 3.90 g of acrylic acid, 9.0 g of acrylamide (50% strength), 59.70 g of n-butyl acrylate, 105.0 g of tert-butyl methacrylate, 126.0 g of methyl methacrylate and 40 g of a 3% strength aqueous solution of sodium pyrophosphate.

After the end of feed 2, stirring was effected for a further 15 min and neutralization was effected with 13.08 g of sodium hydroxide solution (6.5% strength aqueous solution). Thereafter, 11.82 g of tert-butyl hydroperoxide (1.5% strength aqueous solution) and 11.82 g of ascorbic acid (1.5% strength aqueous solution) were metered in 60 min. After the end of the additions, 16.54 g of water were added.

Thereafter, the dispersion was cooled, neutralized with 20.88 g of sodium hydroxide solution (4.9% strength aqueous solution) and filtered over a 125 μm filter. 1.23 kg of an approximately 50% strength coagulate-free dispersion were obtained.

### Preparation of the Tert-Butyl Acrylate-Containing Dispersion in Example S

On the basis of the standard dispersion, the t-BA-containing dispersion of example S was prepared.

A mixture of 231.09 g of water, 4.50 g of a 20% strength aqueous solution of arylsulfonate, 0.12 g of copper(II) sulfate and 29.73 g of feed 1 was initially taken in a tank equipped with stirrer, thermometer, reflux condenser and feed vessels. Feed 1 consisted of 147.89 g of water, 8.0 g of a 45% strength aqueous solution of dodecyldiphenyl ether disulfonic acid sodium salt, 12.0 g of a 20% strength aqueous solution of a C₁₆-C₁₈-fatty alcohol polyethoxylate (18EO), 7.80 g of acrylic acid, 18.0 g of acrylamide (50% strength), 195.0 g of n-butyl acrylate, 210.0 g of tert-butyl acrylate, 88.2 g of methyl methacrylate, 90.0 g of vinyl acetate and 80.0 g of a 3% strength aqueous solution of sodium pyrophosphate.

The initially taken mixture was heated to 90° C. with stirring. Thereafter, 3.43 g of a 7% strength aqueous solution of sodium peroxodisulfate were added while maintaining this temperature and stirring was effected for 5 min. Thereafter, feed 1 was metered in in 150 min and, simultaneously therewith, 36.86 g of a 7% strength aqueous solution of sodium peroxodisulfate were metered in in 180 min.

After the end of feed 1, stirring was effected for a further 15 min and neutralization was effected with 13.08 g of sodium hydroxide solution (6.5% strength aqueous solution). Thereafter, 11.82 g of tert-butyl hydroperoxide (1.5% strength aqueous solution) and 11.82 g of ascorbic acid (1.5% strength aqueous solution) were metered in 60 min. After the end of the additions, 34.97 g of water were added.

Thereafter, the dispersion was cooled, neutralized with 20.88 g of sodium hydroxide solution (4.9% strength aqueous solution) and filtered over a 125 μm filter. 1.22 kg of an approximately 50% strength coagulate-free dispersion were obtained.

TABLE 2
A table with the physical data for the various dispersions prepared follows:

| | |
|---|---|
| A | standard dispersion |
| B-D | comparative dispersions |
| E to J and L to U | t-BA-containing dispersions |
| K | t-BMA-containing dispersion |

| | | Solids | | Particle | |
|---|---|---|---|---|---|
| | | content | LT value | size | Tg |
| Name | Description | (%) | (%) | (nm) | (° C.) |
| A | n-BA (49.2%)/MMA (48%) | 48.2 | 87 | 135 | 17 |
| B | S (41.2%)/n-BA (56%) | 39.0 | 83 | 121 | 13 |
| C | MMA (48.2%)/EHA (49%) | 39.5 | 86 | 135 | 12 |
| D | S (53.2%)/EHA (44%) | 39.4 | 79 | 124 | 20 |
| E | t-BA (50%)/n-BA (37.2%)/MMA (10%) | 48.2 | 89 | 135 | 14 |
| F | t-BA (30%)/n-BA (40.8%)/MMA (26.4%) | 48.8 | 86 | 141 | 16 |
| G | t-BA (30%)/n-BA (41%)/S (26.2%) | 48.3 | 90 | 109 | 21 |
| H | t-BA (45%)/n-BA (32.2%)/VAc (20%) | 47.0 | 92 | 119 | 11 |
| I | t-BA (50%)/n-BA (32.9%)/VAc (14.3%) | 47.9 | 91 | 121 | 11 |
| J | t-BA (30%)/n-BA (36.4%)/MMA (16.8%)/VAc (14%) | 48.2 | 87 | 138 | 18 |
| K | tBMA (48%)/n-BA (49.2%) | 37.3 | 85 | 147 | 21 |
| L | t-BA (35%)/n-BA (30.7%)/MMA (31.5%) | 48.8 | 86 | 143 | 25 |
| M | t-BA (49%)/n-BA (8.2%)/EA (20%)/VAc (20%) | 48.1 | 88 | 135 | 20 |
| N | t-BA (35%)/n-BA (26.2%)/MMA (21%)/VAc (15%) | 47.4 | 93 | 111 | 12 |
| O | t-BA (35%)/n-BA (17.6%)/MMA (24.6%)/EA (20%) | 47.3 | 88 | 131 | 24 |
| P | t-BA (30%)/n-BA (38.4%)/MMA (28.8%) | 49.0 | 89 | 127 | 19 |
| Q | t-BA (35%)/n-BA (37.2%)/MMA (25%) | 48.8 | 88 | 133 | 21 |
| R | t-BA (55%)/n-BA (27.9%)/VAc (14.3%) | 48.3 | 92 | 115 | 21 |
| S | t-BA (35%)/n-BA (32.5%)/MMA (14.7%)/VAc (15%) | 48.5 | 90 | 133 | 18 |
| T | t-BA (35%)/n-BA (27.2%)/MMA (20%)/EA (15%) | 48.5 | 87 | 145 | 19 |
| U | t-BA (35%)/n-BA (23.7%)/MMA (18.5%)/EA (20%) | 48.9 | 91 | 122 | 19 |

The solids content was determined gravimetrically, the pH with a glass probe in the undiluted state; LT is the transparency of a 0.01% by weight dispersion, which was determined with a photometer (instrument: Hach DR/2010) at wavelength 600 nm; particle size was determined by light scattering (instrument: High Performance Particle Sizer HPPS 5001 from Malvern Instruments); the glass transition temperature was determined by means of DSC (instrument: DSC Q2000 V24.4, Build 116).

Testing of the Example Dispersions

Thermogravimetric Analysis

The dispersions were analyzed by a thermogravimetric analysis (TGA) in which the change in mass of a sample is measured as a function of the temperature and time. The TG50 apparatus from Mettler (Mettler M3 balance) was used.

Films approximately 1 mm thick are prepared from the dispersions by drying (2 days at 23° C.). From 10 to 15 mg of the film are weighed into a small crucible of refractory inert material (e.g. platinum). The sample is heated to temperatures up to 900° C. in an oven. The sample holder is coupled to a microbalance which registers the changes in mass of the sample during the heating process. A thermocouple tightly fixed to the crucible measures the temperature. During the analysis, the sample space is flushed with various gases depending on requirements.

First, the sample was heated from 30° C. to 550° C. at a rate of 10° C./min under nitrogen and then from 550° C. to 900° C. at a rate of 10° C./min under air. The decomposition is measured as a graph of weight decrease against temperature.

Thermogravimetric analyses of the t-BA-containing dispersion films (examples E to J & L to O) were carried out with respect to the standard (example A). The following conclusions can be drawn from the comparison of the pyrolysis curves. The standard film and the comparative polymer films from examples B, C and D do not differ significantly.

For all dispersion films, no decrease in weight is observed below 200-210° C., i.e. no decomposition of the polymer chains. From 210° C., the t-BA-containing polymers show a substantial decrease in weight compared to the standard: at 350° C., the proportion remaining is 55-80% in the case of t-BA-containing polymers, while approx. 96-97% of the material is still present in the case of the standard.

Above 390° C., the curves for the t-BA-containing films and those for the standard intersect: this means that, within this temperature range, the standard film decomposes and releases combustible pyrolysis gases to a much greater degree than the t-BA-containing films. Normal fires have combustion temperatures of about 400-500° C. If polymers within this temperature range released pyrolysis gases, they would thus support the fire and are less suitable for the desired use. If the polymers already released material below this temperature, much less polymer remains to supply the fire within this critical temperature range. The best results were exhibited by the n-BA/t-BAA/Ac terpolymers: in the case of these, the proportion of fire-promoting residue is only approx. 35% of the starting material (at 410° C.).

The results of the TGA measurements do indeed lead under practical conditions to improved fire behavior, as shown by the following “fire tests”.

“Fire Tests”

In each case a float-applied render formulation was produced from the above dispersions, according to the following formulation:

26.4 g of dispersion, approximately 50% strength
1.6 g of Calgon N, 25% (dispersant, BK Giulini)
0.6 g of Parmetol A26 (biocide, Schülke & Mayr)
0.6 g of Agitan 280 (antifoam, Münzing Chemie GmbH)
1.6 g of Latekoll D, 8% (thickener, BASF SE)
2 g of mineral spirit K60 (solvent)
2 g of butyldiglycol (solvent)

### 1.2 g of Basophob WDS (BASF SE)

5.6 g of Kronos 2044 (titanium dioxide, white pigment, Kronos Titan)
79 g of Omyacarb 40GU (calcium carbonate, filler, Omya GmbH)
51 g of Omyacarb 13000 (calcium carbonate, filler, Omya GmbH)
13 g of Plastorit 0.5 (dulling agent, Luzenac GmbH)
9 g of round quartz gravel 1.5 mm (grade)
6.4 g of water

The render formulation was mixed and in each case 55 g of render were applied to a glass fabric of 5 mm lattice spacing and 10*10 cm size using a trowel and dried for 1 day at room temperature and then for 7 days at 40° C. in a drying oven.

The dry render samples were clamped perpendicularly and the flame of a gas burner (camping gas blowtorch, average burner power) was applied from a distance of 5 cm.

The render comprising comparative dispersion B is burned through after only 37 seconds, i.e. the render is mechanically destroyed in the fire, has acquired holes in the surface and burns even on the back where the flame is not directly applied.

The render comprising comparative dispersion C has burned through after only 60 seconds, i.e. the render is mechanically destroyed in the fire, has acquired holes in the surface and burns even on the back where the flame is not directly applied.

The render comprising comparative dispersion D smokes strongly on flame application but remains mechanically stable, i.e. it does not burn on the back. After flame application for 30 minutes, the test was terminated.

The render comprising the dispersion K according to the invention scarcely smokes on flame application and also remains mechanically stable, i.e. it does not burn on the back. After flame application for 30 minutes, the test was terminated.

Cone Calorimeter Tests

Render Formulation

Renders were produced from the dispersions of Table 1 (experiments A, E to J, P to U) according to the following formulation and applied as above to glass fabric and dried.

66 g of dispersion, approximately 50% strength
4 g of Calgon N, 25% (dispersant)
1.5 g of Parmetol A26 (biocide, Schülke & Mayr)
1.5 g of Agitan 280 (antifoam, Münzing Chemie GmbH)
4 g of Latekoll D, 8% (thickener, BASF SE)
5 g of mineral spirit K60 (solvent)
5 g of butyldiglycol (solvent)

### 3 g of Basophob WDS (BASF SE)

14 g of Kronos 2044 (titanium dioxide, white pigment, Kronos Titan)
180 g of Omyacarb 4000 (calcium carbonate, filler, Omya GmbH)
100 g of Omyacarb 130GU (calcium carbonate, filler, Omya GmbH)
45 g of aluminum hydroxide, 40 μm (flameproofing agent)
32.5 g of Plastorit 0.5 (dulling agent, Luzenac GmbH)
100 g of round quartz gravel 1.5 mm (grade)
27.5 g of water

Experimental Description for “Cone Calorimeter”

The test is effected on test specimens which are subjected to thermal stress with constant irradiance in horizontal orientation by a heat radiator arranged above. In addition, a spark igniter is used. The volume flow rate of the exhaust air fan is set at 0.024 m/s. Alternatively 30 kW/m² or 50 kW/m² was chosen as irradiances. The test lasts for 20 minutes. During the test, the behavior of the test specimens is documented.

Dimensions of the test specimens: for the tests, samples having the dimensions (100×100×3) mm are produced. The test specimens are stored before the test until they have constant mass, but for at least 24 hours at 23° C./50% r. h.

The heat emission rate is calculated via the oxygen consumption, which is determined continuously during the test. The average rate of heat emission (ARHE) over time is calculated as an evaluation parameter and the MAHRE value (maximum value of AHRE, based on the duration of the test) is determined therefrom.

Results

The render samples which were produced from the dispersions A, E-J and P-U were then tested in a cone calorimeter according to the standard of “ISO 5660 part 1: 2002-12, testing the fire behavior”.

For the render samples which were produced from dispersions A and E-J, the maximum value of the average rate of heat emission (MARHE) was evaluated at an incident energy of 30 kW/m². A low numerical value for MAHRE is of course more advantageous for the real fire behavior of a paint or of a render than a high numerical value.

| | | MARHE |
|---|---|---|
| Name | Description | [kW/m²] |
| A | n-BuA (49.2%)/MMA (48%) | 44 |
| E | t-BuA (50%)/n-BuA (37.2%)/MMA (10%) | 41 |
| F | t-BuA (30%)/n-BuA (40.8%)/MMA (26.4%) | 41 |
| G | t-BuA (30%)/n-BuA (41%)/S (26.2%) | 52 |
| H | t-BuA (45%)/n-BuA (32.2%)/VAc (20%) | 33 |
| I | t-BuA (50%)/n-BuA (32.9%)/VAc (14.3%) | 35 |
| J | t-BuA (30%)/n-BuA (36.4%)/MMA (16.8%)/VAc | 42 |
| | (14%) | |

It is clearly evident that the samples with t-BA-containing dispersions have more advantageous MARHE values in the cone fire test. A higher proportion of styrene is harmful in the test, since the proportion of combustibles rises (example G, MAHRE 52; a dispersion of n-BuA (49.2%)/S (48%) even exhibits an MAHRE value of 63). The results were particularly favorable for the specimens whose polymer additionally comprises vinyl acetate (specimen H with MARHE of 33).

For the render samples which were produced from the dispersions P to U, the maximum value of the average rate of heat emission (MARHE) was evaluated in this series at an incident energy of 50 kW/m². Owing to the higher heat radiation used in this test series, the numerical values of the MAHRE are not comparable with those of the test series with 30 kW/m². Within this test series too, a low numerical value for MAHRE is of course more advantageous for the real fire behavior of a paint or of a render than a high numerical value.

| | | MARHE |
|---|---|---|
| Name | Description | [kW/m²] |
| P | t-BuA (30%)/n-BuA (38.4%)/MMA (28.8%) | 61 |
| Q | t-BuA (35%)/n-BuA (37.2%)/MMA (25%) | 55 |
| R | t-BuA (55%)/n-BuA (27.9%)/VAc (14.3%) | 49 |
| S | t-BuA (35%)/n-BuA (32.5%)/MMA (14.7%)/VAc | 53 |
| | (15%) | |
| T | t-BuA (35%)/n-BuA (27.2%)/MMA (20%)/EA (15%) | 61 |
| U | t-BuA (35%)/n-BuA (23.7%)/MMA (18.5%)/EA | 52 |
| | (20%) | |

It is found that the samples with t-BA-containing dispersions tested with 50 kW/m² in the cone fire test have more advantageous MARHE values. In comparison, a straight acrylate dispersion composed of n-BuA (49.2%) and MMA (48%) has an MAHRE value of 70, and a styrene/acrylate dispersion composed of n-BuA (49.2%) and styrene (48%) an MAHRE value of 100. The results were particularly favorable for the specimens whose polymer additionally comprises vinyl acetate or ethyl acrylate.

1. An aqueous polymer dispersion, comprising:
a polymer (P), obtained by a process comprising polymerizing, by free radical emulsion polymerization, (1) an ethylenically unsaturated monomer (M1), and (2) from 20 to 75% by weight of tert-butyl (meth)acrylate.

2. A paint, comprising the dispersion of claim 1.

3. A render, comprising the dispersion of claim 1.

4. A composite heat insulation system, comprising the dispersion of claim 1.

5. A construction adhesive, comprising the dispersion of claim 1.

6. A filling compound, comprising the dispersion of claim 1.

7. A method of improving a fire behavior of a material, the method comprising:
producing the material with the dispersion of claim 1.

8. The dispersion of claim 1,
wherein a content of tert-butyl (meth)acrylate in the dispersion is from 25 to 60% by weight.

9. The dispersion of claim 8,
wherein the content of tert-butyl (meth)acrylate in the dispersion is from 30 to 45% by weight.

10. The dispersion of claim 1,
wherein a content of the monomer (M1) is in the range from 25 to 80% by weight, based on a total weight of monomers in the emulsion polymerization.

11. The dispersion of claim 1,
wherein a main monomer proportion of the monomers monomer M1 (HM) is at least 50% by weight, based on a total weight of the monomers monomer (M1).

12. The dispersion of claim 11, wherein the main monomer proportion (HM) is selected from the group consisting of methyl methacrylate, n-butyl acrylate/vinyl acetate, n-butyl acrylate/methyl methacrylate/vinyl acetate, n-butyl acrylate/ethyl acrylate/vinyl acetate, and n-butyl acrylate/methyl methacrylate/ethyl acrylate.

13. The dispersion of claim 11, wherein a secondary monomer proportion of the monomer M1 (NM) comprises at least one monomer selected from the group consisting of acrylic acid, methacrylic acid, itaconic acid, maleic acid, fumaric acid, maleic anhydride, acrylamide, and methacrylamide.

14. A paint, comprising:
an aqueous polymer dispersion, comprising at least one polymer (P), obtained by a process comprising polymerizing, by free radical emulsion polymerization, an ethylenically unsaturated monomer (M1);
an inorganic filler, an inorganic pigment, or both;
a customary assistant; and
water.

15. A composite heat insulation system (CHIS), comprising:
the polymer dispersion of claim 1,
an adhesive layer,
a heat insulation board,
a filling compound with embedded reinforcement,
a finish coat, and
a further customary assistant.

16. A render, comprising:
the polymer dispersion of claim 1;
a wetting agent, a dispersant, or both;
an inorganic pigment, an inorganic filler, or both; and
a further customary assistant.

17. The render of claim 16, wherein the further customary assistant comprises at least one customary assistant selected from the group consisting of a preservative, an antifoam, a thickener, a film forming assistant, and a water repellant.

18. The dispersion of claim 11,
wherein the main monomer proportion of the monomer M1 (HM) is at least 60% by weight, based on a total weight of the monomer (M1).

19. The dispersion of claim 18,
wherein the main monomer proportion of the monomer M1 (HM) is at least 80% by weight, based on a total weight of the monomer (M1).

20. The dispersion of claim 1, wherein the polymerizing comprises polymerizing with a crosslinking agent.
